(19) United States
(12) Patent Application Publication
(10) Pub. No.: US 2009/0022597 A1
(43) Pub. Date: Jan. 22, 2009

(54) Apparatus For The Generation Of Power From A Flowing Fluid

(76) Inventor: Malcolm MacLean Bowie, Aberdeenshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/791,775

(22) PCT Filed: Nov. 30, 2005
(86) PCT No.: PCT/GB2005/004586

§ 371 Date: Apr. 8, 2008

(30) Foreign Application Priority Data
Nov. 30, 2004 (GB) 0426256.4

(51) Int. Cl. F03B 3/12; F03D 3/00

(52) U.S. Cl. 416/223 R; 416/176; 290/54

(57) ABSTRACT

Apparatus for the generation of electrical or mechanical energy from a flowing fluid. The apparatus includes at least one blade of substantially helical configuration. The blade has a plurality of blade sections. Action of the flowing fluid on the blade causes it to rotate around its axis. The rotational motion is used to generate electrical or mechanical energy. Also disclosed is a helical blade wherein the pitch length and/or radii varies along the length of the helical blade profile.

The invention relates to the generation of electromotive or mechanical power from a fluid such as wind or water sources and in particular apparatus for such generation having increased practicability over traditional wind or water turbine designs.

The generation of electromotive power from the movement of water or wind currently relies upon blades in the flow regime. These blades, which when viewed along the axis of rotation represent a small portion of the swept area, are required to be long in order to maximise surface area, and consequently efficiency, of electromotive power generation. This requires sufficient clearance for the rotation of the blades, by either deep water or tall windmills.

The installation and anchoring of such systems requires complex and/or costly schedules due to the heights and depths required for their efficiency. Furthermore the resultant overturning moment from such tall structures results in large base support structures being required. Also, large blades can be fouled or damage animal life in an underwater environment.

In order to generate electrical power from rivers, there are currently limited options, with the traditional generating methods of pelter wheels or dam construction being the most commonly associated solutions. The environmental impact and capital cost of the provision of dams is well documented and is also severely limited by geographical and social suitability.

The efficient generation of electromotive power from renewable sources requires investment in new technologies and concepts. An additional consideration to development is the environmental impact, whether it be via noise, visual, moving parts, interruption or change to animal or plant habitats and access restrictions.

However, on a national level the power generation capacity in terms of the capital and operating cost of such concepts need to be sufficiently low in order to compete with traditional non-renewable means of generating electricity. Reducing these costs therefore, is of great importance, and one way of doing this is reducing storage, transportation, installation and repair costs.

On a local community or remote location, whilst the higher unit cost may be acceptable the capital costs may deter solutions from being pursued especially if frequent outages of the power source occur.

In a first aspect of the invention there is provided apparatus for the generation of electrical or mechanical energy from a flowing fluid, said apparatus comprising at least one blade of substantially helical configuration the or each blade consists of a plurality of blade sections, wherein in use, the action of the flowing fluid on said blade(s) causes it to rotate around its axis, said rotational motion being used to generate said electrical or mechanical energy.

The apparatus may further comprise a spindle wherein said at least one blade is attached to and shares substantially the same axis as said spindle.

Each blade may consist of a plurality of either helical or non-helical sections forming a single helical configuration. For the purposes of clarity, in the latter cases such individual sections are collectively referred to as a single blade as they form part of the same helix and for the purposes of the invention act as a single helical blade. The single blade may also be formed by a membrane over said sections, thus enhancing the helical profile of the blade.

An advantage of forming the helical blade out of individual sections is that it eases transportation, the sections being easier to both store and transport. Also installation, maintenance and repair is simplified, as intervention is minimised. In additional the sections may be rotated relative to each other to form a helical blade configuration of different pitch lengths.

The spindle may have more than one helical blade attached, in similar helical configurations, offset angularly about a common axis. Said similar helical configurations may in particular have the same radii and heights.

Preferably, the angle between the axis of rotation of a spindle and the direction of flow of the fluid is kept less than 30 degrees.

In a preferred embodiment the area presented by the blade(s), when viewed along the spindle axis is equal to or greater than 25% of the swept area. Where the blade is composed of individual helical sections they may present an area of up to 50% of the swept area. The pitch of the helical profile x may be greater than 5% of the blade width.

Said apparatus may further comprise a support frame.

Said apparatus may further comprise a float to allow it to float with the blades either completely or partially submerged. Alternatively it may further comprise a base for installing on the sea/river bed. Said apparatus may be mounted to the base or attached to the float in such a way that it is free to adjust its orientation relative to the base, the float or combination of floats in order to face the direction of water flow.

The apparatus may comprise a plurality of spindles arranged in series, or in parallel, or any combination thereof, said spindles either directly mechanically connected or mechanical separate. Preferably the angle between the axes of any 2 spindles is between 0 and 60 degrees. Said spindles may each be attached to separate support frames or buoys or to a single support frame or buoy.

Two or more complete apparatus may be connected in either series, parallel or any combination thereof utilising the same anchoring system or point(s).

The generation of electrical power may be by either generating equipment onboard the apparatus, or by remote generating equipment a distance from the apparatus.

Mechanical or motive power may be generated by rotational drivers or pumped fluid mobilised by said the apparatus.

The apparatus may be adapted to be installed in a river or sea environment. It may be installed floating on or under the water. The apparatus may be fixed in position to the seabed, estuary or riverbed or moored by one or more anchor lines to either the seabed, the land, or a separate man-made structure. It may be either permanently fixed in the direction of water flow, or allowed to rotate (for example, around an anchoring point) to continually face the direction of flow of the water. The apparatus may be also connected to a separate floating or fixed structure. The connection to the ground, seabed or riverbed may be via one or more mooring line(s) the composition of which may typically be any combination of wire, chain or rope segments or rigid connecting elements.

In a further aspect of the invention there is provided apparatus for the generation of electrical or mechanical energy from a flowing fluid, said apparatus comprising at least one blade of substantially helical configuration, wherein the pitch length and/or radius varies along the length of the helical blade profile, and wherein in use, the action of the flowing fluid on said blade(s) causes it to rotate around its axis, said rotational motion being used to generate said electrical or mechanical energy.

An advantage of varying the radius is that fouling of the blade by water-borne objects is minimised due to its smooth profile. The pitch length may be varied along its length in order to optimise the flow profile and compensate for any reduction or disturbance in flow regime along the blade length.

Other optional features of the invention are as disclosed in the appended claims.

### BRIEF DESCRIPTION OF THE DRAWINGS

Embodiments of the invention will now be described, by way of example only, by reference to the accompanying drawings, in which:

FIG. 1 shows apparatus according to an embodiment of the invention having a single helical blade;

FIG. 2 shows apparatus according to an embodiment of the invention having a double helical blade;

FIG. 3 shows apparatus according to an embodiment of the invention having two spindles in parallel;

FIG. 4 shows apparatus according to an embodiment of the invention having two mechanically separate spindles in series;

FIG. 5 shows apparatus according to a further embodiment of the invention having two spindles in series and mechanically connected;

FIG. 6 shows apparatus according to an embodiment of the invention installed in a first configuration in a location with water predominately flowing in one direction;

FIG. 7 shows apparatus according to an embodiment of the invention installed in a second configuration in a location where water flows in alternative directions;

FIG. 8 shows apparatus according to an embodiment of the invention installed in a third configuration with a single anchoring point under the water;

FIG. 9 shows apparatus according to an embodiment of the invention installed in a fourth configuration anchored under the water;

FIG. 10 shows apparatus according to an embodiment of the invention installed in a fifth configuration anchored under the water and able to rotate to face the flow of water;

FIG. 11 shows apparatus according to an embodiment of the invention having two spindles in parallel, but with blades of varying radii;

FIG. 12 shows apparatus consisting of helical blade sections which form one-quarter of a pitch length each;

FIG. 13 shows apparatus consisting of a number of non-helical sections rotated relative to each other to form a helical blade profile, held in place by friction between sections;

FIG. 14 shows apparatus consisting of a number of non-helical sections rotated relative to each other to form a helical blade profile, held in place by a fastening strip on the outer edge; and

FIG. 15 show apparatus consisting of a number of non-helical sections rotated relative to each other with a membrane between the sections thus forming a helical profile.

### DETAILED DESCRIPTION OF THE EMBODIMENTS

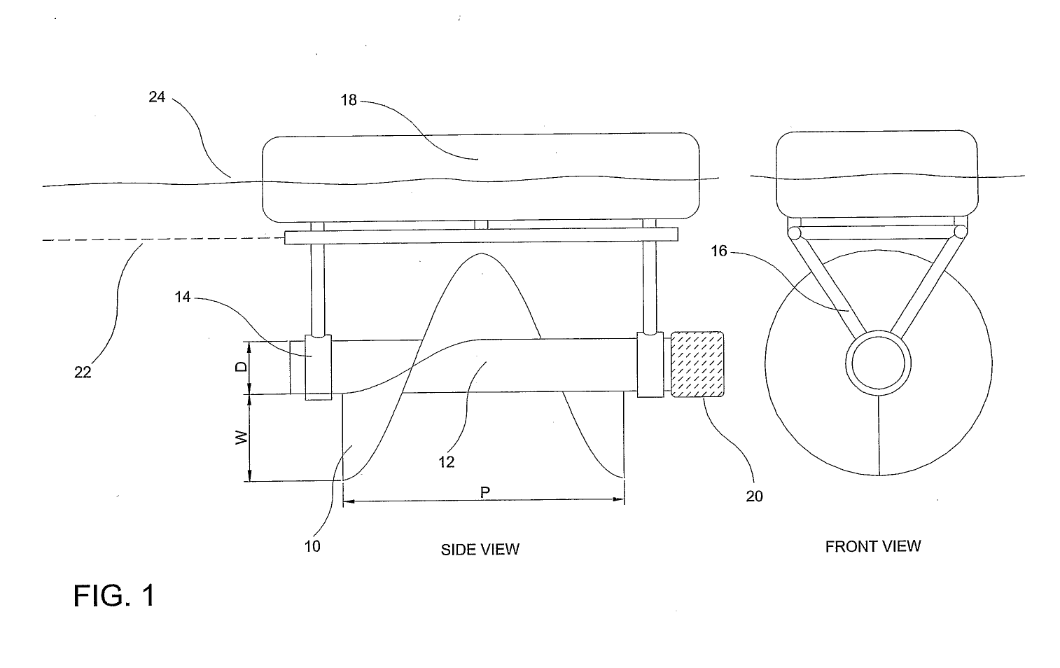

FIG. 1 shows an embodiment of the invention. It comprises a spindle 12, to which there is attached a helical blade 10, the helix and spindle sharing the same axis. The spindle is rotatably mounted to a supporting frame 16 around pivots 14. The blade may be split into a number of blade sections to allow assembly and replacement without removing spindle. The whole structure has a float 18 attached to its top. A mooring line 22 is attached to the frame 16 to keep the device in place. W indicates the blade width and P the blade pitch. D indicates the spindle diameter. The generating equipment 20 is shown connected directly to the spindle of the apparatus.

In use the device is moored in a river, stream, ocean or any location of flowing water, with float 18 either partially (as shown) or fully submerged. The blade 10 and spindle 12 attached to the underside of this float 18 is therefore completely submerged (although the device will function with the blade only partially submerged), and sensibly facing the direction of the water flow. As the water flows onto the blade 10, its helical configuration causes it to turn, which causes the spindle 12 to turn also.

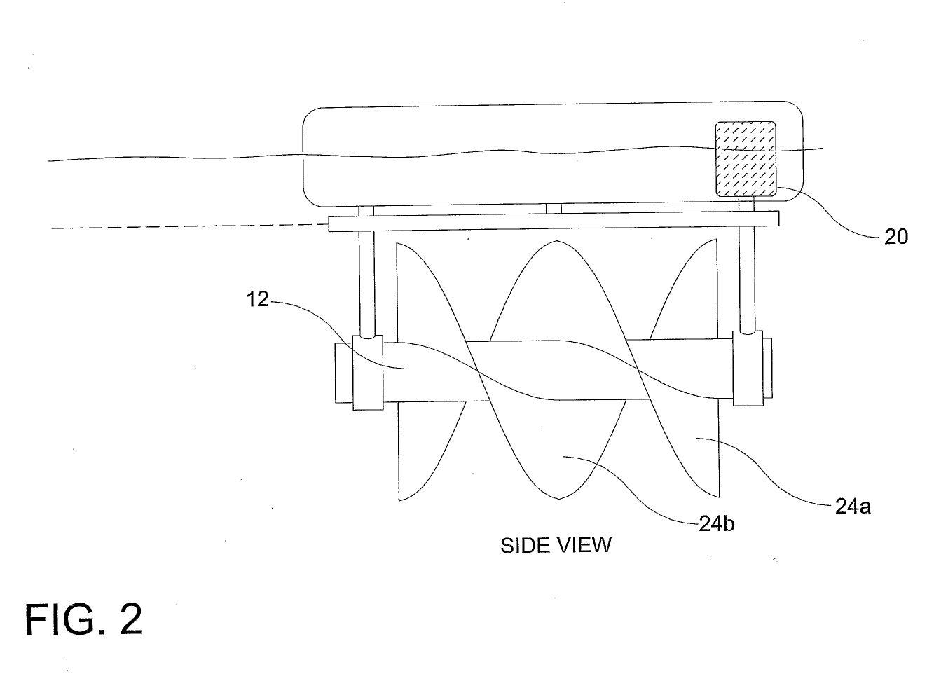

FIG. 2 shows an improved variation on the device of FIG. 1. It has two helical blades 24a, 24b sharing the same axis, attached to the spindle 12. This improves the efficiency of the device ensuring that more of the energy from the flowing water is converted into turning energy of the spindle 12 due to the increased blade 24a, 24b surface area in contact with the flowing water. It should be noted that the blade surface area here has been doubled without increasing the overall dimensions of the device, something not possible with conventional designs. This surface area can be increased even further by adding further blades to the same spindles. The helical profile of the blades is illustrated as being provided by individual sections which themselves may not necessarily be helical in profile. The generating equipment 20 is shown within the buoyancy element and mechanically connected to the spindle 12.

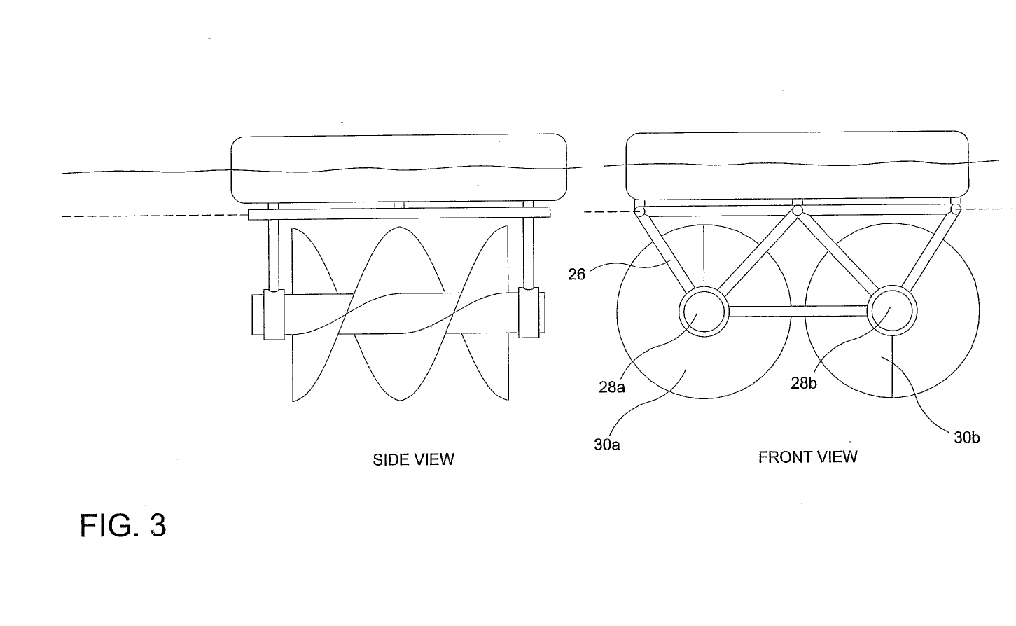

FIG. 3 shows a variation having two spindles 28a, 28b mounted in parallel to a frame 26. Helical blades 30a, 30b are attached to these spindles as with FIG. 2 (although this could also be the single blade arrangement of FIG. 1). Obviously any number of spindles could also be installed in parallel in this manner, either in units of two (or more) as depicted, or all sharing a single frame.

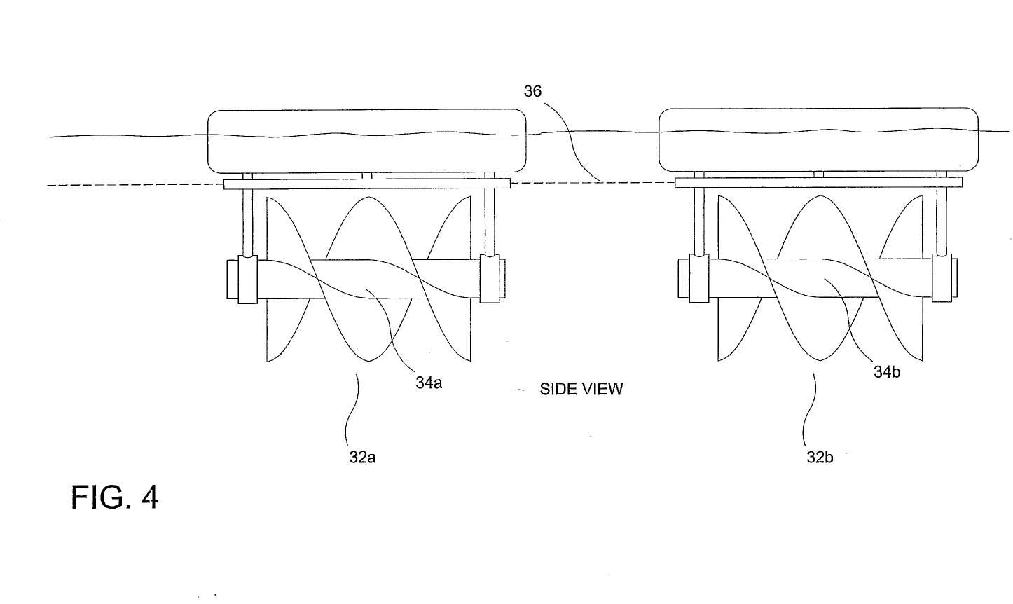

FIG. 4 shows a variation where devices 32 as depicted in FIG. 2 (they could, of course, be devices as depicted in FIG. 1) are arranged in series, connected by chain or any other connecting elements 36. Devices such as those depicted in FIG. 3 with spindles arranged in parallel could also be arranged in this manner thus forming an array.

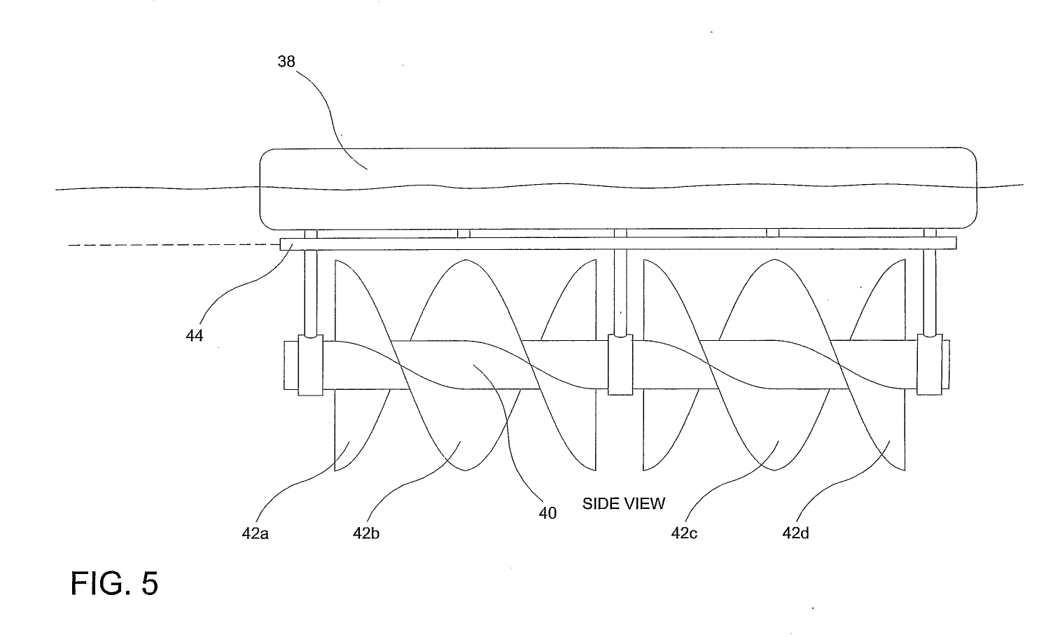

FIG. 5 shows an embodiment where a long single spindle 40 is used with separate sets of blades 42a, 42b, 42c, 42d along its length. The frame 44 and float 38 have also been extended to accommodate the longer spindle. In this drawing two sets of two blades are shown, although more may be placed in series on a longer spindle. Two or more apparatus may be connected in series, parallel or any combination thereof using the basic principles shown in FIG. 3 & 4.

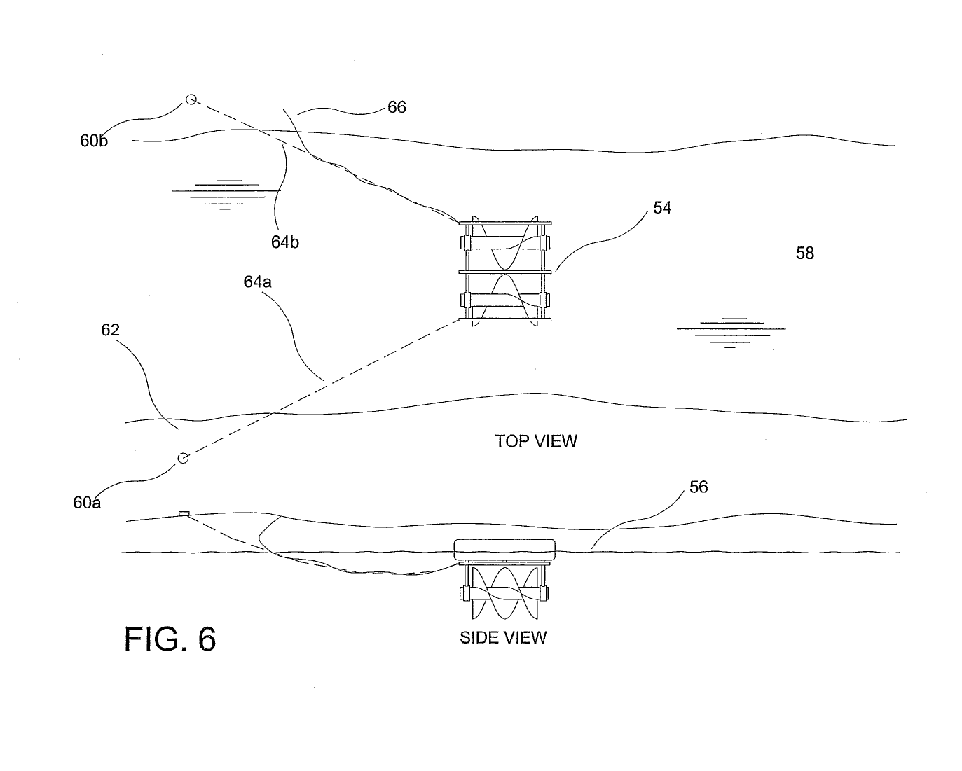

FIG. 6 shows a suitable mooring arrangement for any of the devices 54 described above. This shows the device 54 moored floating on the surface 56 of a river, stream or estuary 58 by mooring lines 64a, 64b each attached to respective anchoring points 60a, 60b on the bank. The number of moorings may be greater than two and the anchoring points may be under water. This fixes the device at a particular position and heading on the surface 56. This allows simple installation and recovery of the apparatus. The electromotive power may be transmitted by power cable or hose 66.

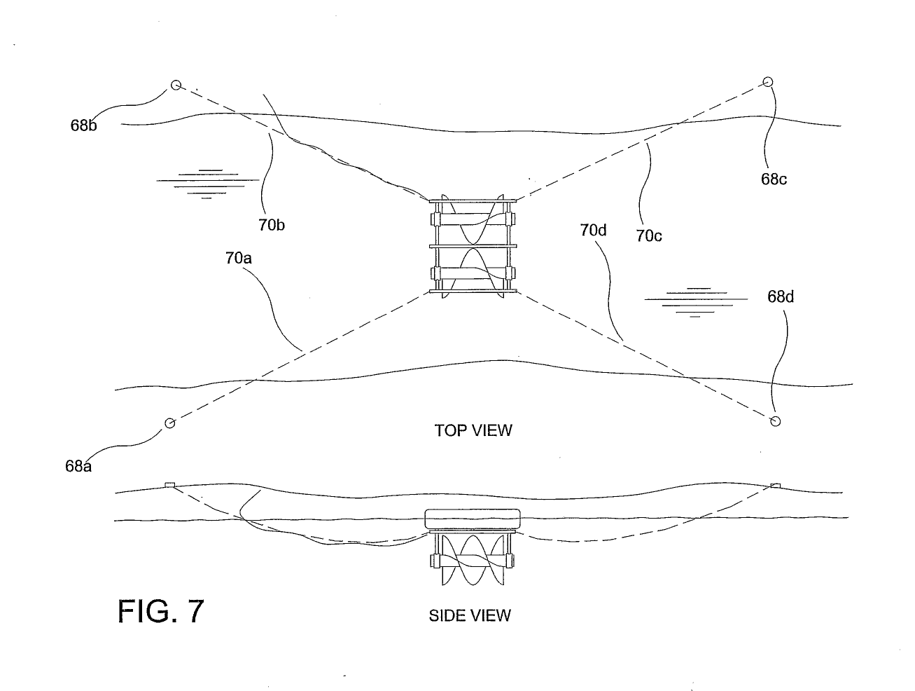

FIG. 7 shows an alternative mooring arrangement whereby a spread of mooring lines 70a, 70b, 70c, 70d are connected to anchoring points 68a, 68b, 68c, 68d thus allowing flow of water from alternate directions.

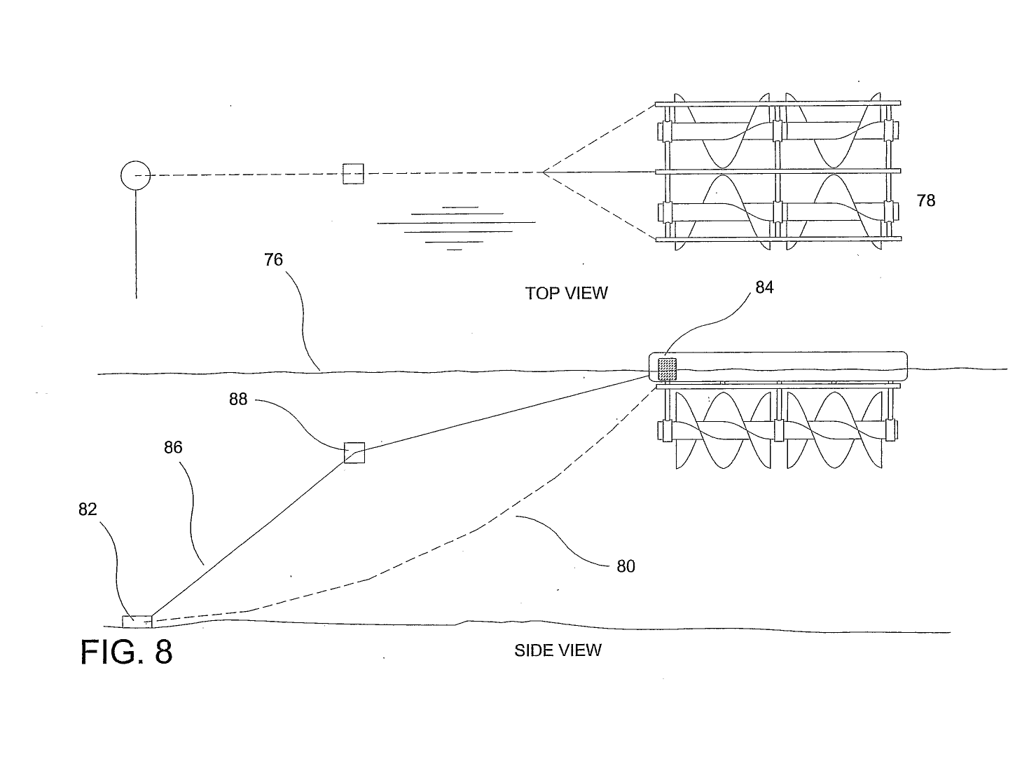

FIG. 8 shows an alternative mooring arrangement whereby the device 78 is connected by a mooring line 80 to an anchoring point on the riverbed or seabed 82. The arrangement shows an electromotive generating unit 84 onboard as in FIG. 2. The electromotive power or energy is transmitted from the device in this case via a cable or hose 86 with a buoyancy unit 88.

The apparatus is shown floating but may be fully submerged. The anchoring point may be design to allow the apparatus to rotate around the anchor point to sensibly face the flow direction and hence a swivel may be incorporated into the anchor point to facilitate such a capability.

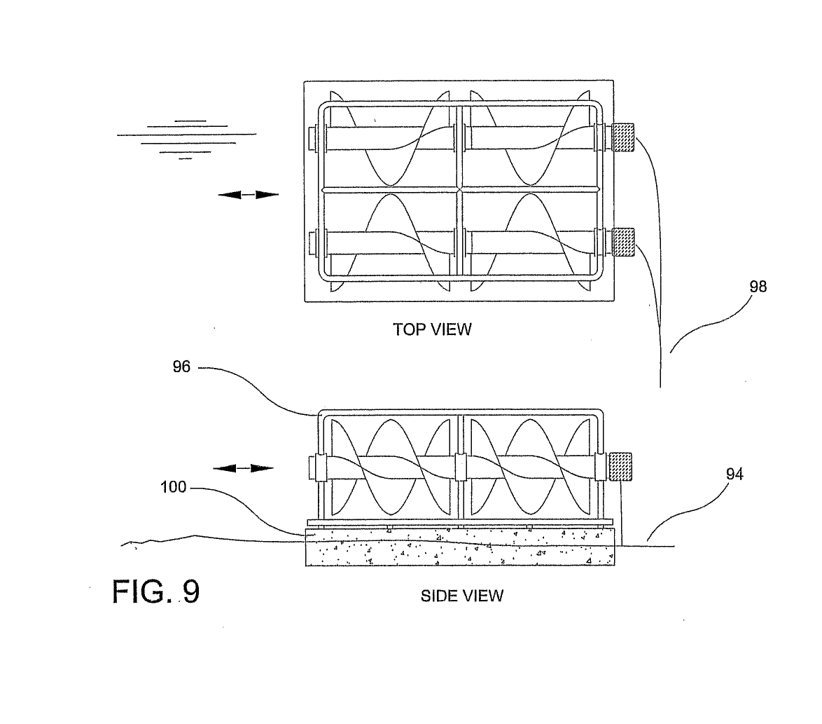

FIG. 9 shows the device anchored directly to the seabed or riverbed 94 using a support base 100. The frame 96 is mounted on the support base and electromotive power transmitted via cable or hoses 98.

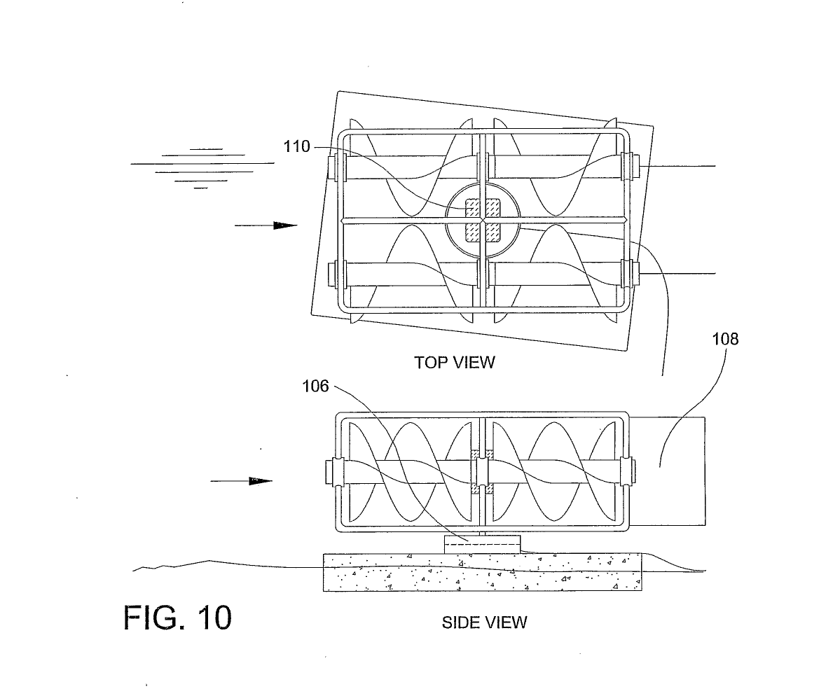

FIG. 10 shows an alternative where the device is anchored directly to the seabed or riverbed via a swivel connection 106. The apparatus rotates to face the flow direction via vanes 108. The generating set 110 is shown in this alternative centrally. The rotation of the apparatus may also be achieved via a mechanical drive.

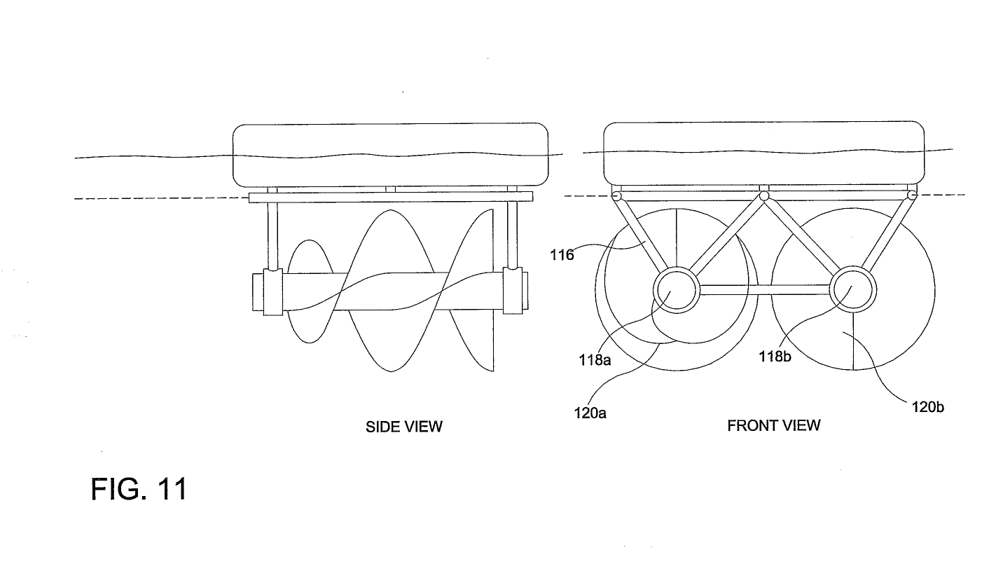

FIG. 11 shows a variation having two spindles 118a, 118b mounted in parallel to a frame 116. Helical blades 120a, 120b are attached to these spindles as with FIG. 3, but the blades have a varying radii along part of their length. The radii may be continuously varying along the whole blade length.

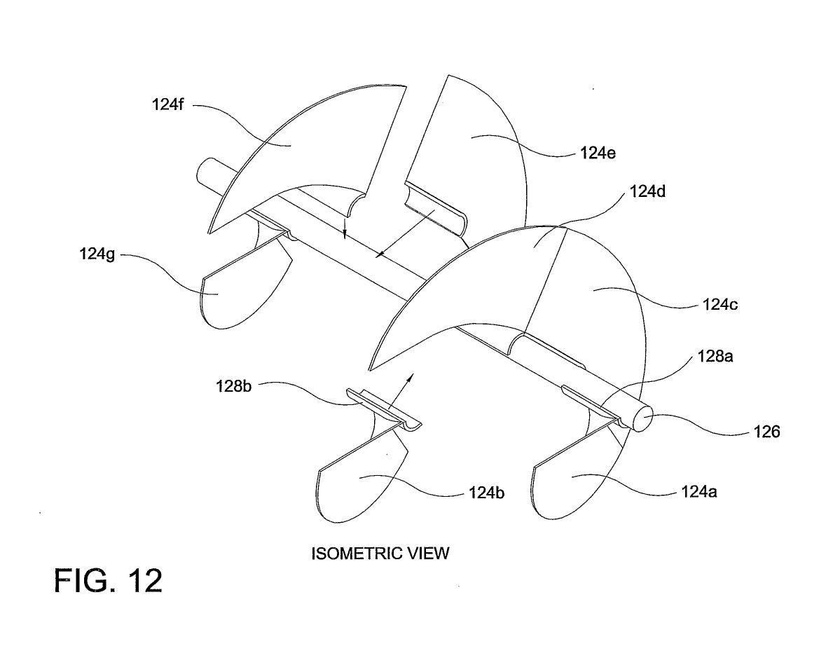

FIG. 12 shows a helical blade configuration composed of helical sections 124a to 124g which form one-third of a pitch length each. The sections may form up to one-half the pitch length, in order to remove easily. The sections may be attached onto the spindle 126 via an interface 128 or directly onto the spindle 126. Therefore the blade may be installed or removed without having to remove spindle from supporting structure. Alternatively each helical section 124a,124b,124c may be attached to each other, thus avoiding the requirement for a spindle.

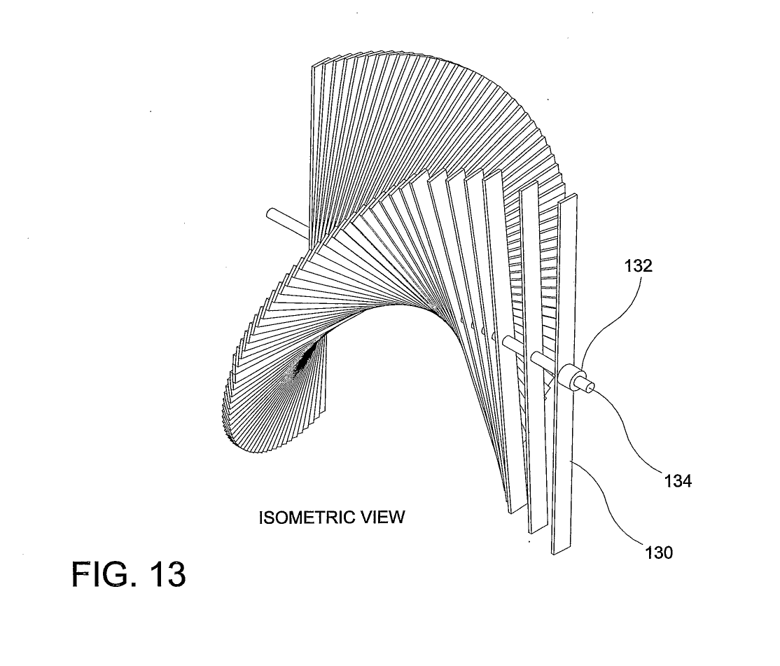

FIG. 13 shows a helical blade made up of a plurality of rectangular (in this example) cross-section blade sections 130, thus forming a helical blade profile. Each of these blade sections may, in fact, have any profile providing that, in plurality, they form a substantially helical profile. The rotation of each sections relative to each other may be prevented by mechanically bonding together the blade sections 130 or by friction between each section, using the fastener 132 to cause each of said blade sections 130 to press together. In the latter case the fastener 132 can be loosened and the pitch length of the helical blade can be adjusted by the rotation of individual blade sections 130 around the blade's axis. The spindle 134 may not be required should the sections 130 be mechanically bonded together.

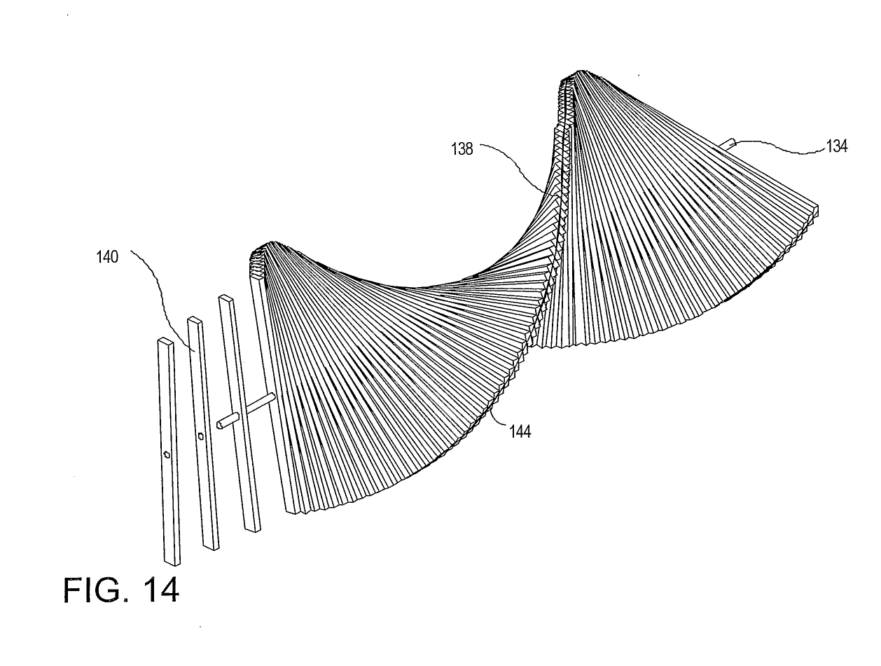

FIG. 14 shows a variation where the sections are prevented from rotating relative to each other by a retaining strip along the outer edge 144. The sections 140 form a profile of one and a half pitch length and are shown engaging with the spindle 134 via a hole in each section 140.

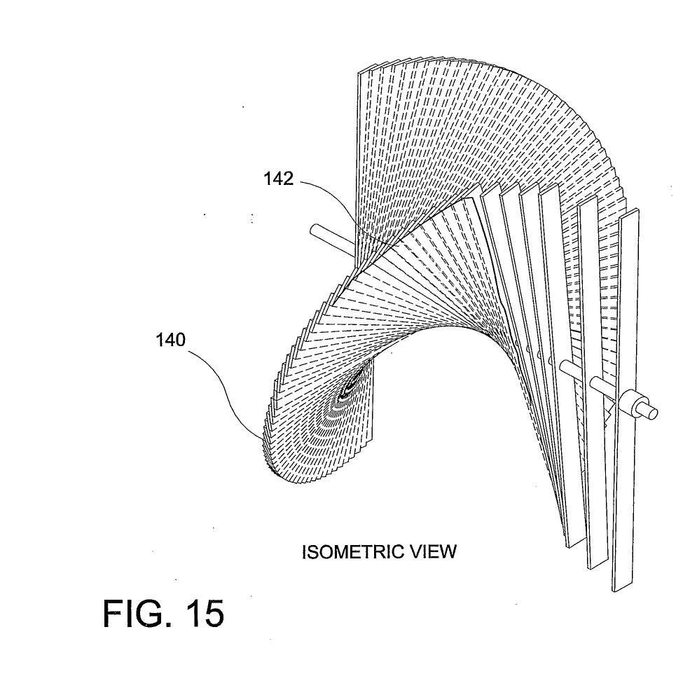

FIG. 15. shows a variation whereby a membrane 142 is formed over said sections 140 to form a smooth helical profile of blade. The sections 140 may not necessarily be continuous or in contact with each other.

It should be noted that any of the above embodiments can be combined with one or more of the other embodiments to form further embodiments falling within the scope of the invention. For instance, a number of devices can be arranged in both series and parallel to form an array. The invention or device may be used fully underwater or floating in streams, rivers, estuaries or open ocean or anywhere there is a flow of water. The generated electromotive power could be pumped fluids or electricity through power cables.

The embodiments above are for illustrative purposes only and other embodiments and variations can be envisaged without departing from the spirit or scope of the invention. In particular, they all describe devices for the generation of energy from flowing water, that is from streams, rivers, estuaries, the sea or ocean. Furthermore it is possible that the basic invention can be adapted to work as a wind turbine. Also a version without a spindle can be envisaged having simply a helical blade being rotatably mounted around its axis.

1. Apparatus for the generation of electrical or mechanical energy from a flowing fluid, said apparatus comprising at least one blade of substantially helical configuration, the or each blade consisting of a plurality of blade sections, wherein in use, the action of the flowing fluid on said blade(s) causes it to rotate around its axis, said rotational motion being used to generate electrical or mechanical energy.

2. Apparatus as claimed in claim 1 wherein said blade sections are helical or part helical in shape.

3. Apparatus as claimed in claim 2 wherein said each turn of the helical blade is comprised of two or more part-helical blade sections, each having a length that equal to or less than one-half of the pitch of the completed helical blade.

4. Apparatus as claimed in claim 1 wherein said blade sections attach together directly to form said helical blade.

5. Apparatus as claimed in claim 1 wherein said blade sections are not helical in shape.

6. Apparatus as claimed in claim 5 wherein rotation of each blade section relative to each other is prevented by friction between each blade section, the blade sections being held tightly together.

7. Apparatus as claimed in claim 5 wherein rotation of each blade section relative to each other is prevented by a retaining strip sited along the outer edge of the blade.

8. Apparatus as claimed in claim 5 wherein rotation of each blade section relative to each other is prevented by mechanically bonding together the blade sections.

9. Apparatus as claimed in claim 5 where the pitch length of the helical blade is adjustable by rotation of individual blade sections around the blade's axis.

10. Apparatus as claimed in any of claims 5 wherein said blade sections are elongate rectangular in shape.

11. Apparatus as claimed in claim 1 wherein said fluid is water.

12. Apparatus as claimed in claim 1 wherein said fluid is air.

13. Apparatus as claimed in claim 1 wherein the blade has a pitch length and/or radii that varies along the length of the helical blade profile.

14. Apparatus as claimed in claim 1 where the helical blade configuration is formed by a membrane over said blade sections.

15. Apparatus as claimed in claim 1 wherein there is provided more than one blade in similar helical configurations, offset angularly about a common axis.

16. Apparatus as claimed in claim 6 wherein said similar helical configurations have in particular the same radii and heights.

17. Apparatus as claimed in claim 1 further comprising a spindle wherein said at least one blade is attached to and shares substantially the same axis as said spindle.

18. Apparatus as claimed in claim 17 wherein the blade sections can be installed, removed or replaced without having to remove the spindle from any supporting structure.

19.-27. (canceled)

28. Apparatus as claimed in claim 1 wherein the angle between the axis of rotation of the at least one blade and the direction of flow of the fluid is kept less than 30 degrees.

29. Apparatus as claimed in claim 1 wherein the area presented by the blade(s), when viewed along the spindle axis is greater than 25% of the swept area.

30. Apparatus as claimed in claim 1 wherein the blade comprises of individual helical profiles or blade sections of one half pitch length or less or 270 degrees or less of swept area when viewed along axis of rotation.

31. Apparatus as claimed in claim 1 wherein the pitch of the helical profile is greater than 5% of the blade width.

32. (canceled)

33. Apparatus as claimed in claim 1 further comprising a float or number of floats to allow said apparatus to float with the blades either completely or partially submerged.

34. Apparatus as claimed in claim 1 further comprising a base for installing on a sea/river bed.

35. Apparatus as claimed in claim 33 further comprising rotation means such that said apparatus is mounted to the base or attached to the float in such a way that it is free to adjust its orientation relative to the base or float in order to face the direction of fluid flow.

36. Apparatus as claimed in claim 1 further comprising generating equipment onboard for the generation of electrical power.

37. Apparatus as claimed in claim 1 wherein there is further provided remote generating equipment a distance from the apparatus.

38. Apparatus as claimed in claim 1 further comprising rotational drivers for the generation of mechanical or motive power.

39. Apparatus as claimed in claim 1 further comprising means for the generation of mechanical or motive power from pumped fluid mobilised by said the apparatus.

40. (canceled)

41. An arrangement of two or more complete apparatus as claimed in claim 1 connected in either series, parallel or any combination thereof utilising the same anchoring system or point(s).

42. Method of generating electrical or mechanical energy from flowing water using the apparatus as claimed in claim 1 wherein said apparatus is installed such that the blades are partially or completely submerged in said flowing water.

43. Method as claimed in claim 42 wherein said apparatus is installed floating on or below the water surface.

44. Method as claimed in claim 43 wherein said apparatus is moored by one or more anchor lines to either the seabed or the land.

45. Method as claimed in claim 42 wherein said apparatus is installed fixed in position to the seabed, estuary or riverbed.

46. Method as claimed in claim 45 wherein the connection to the seabed estuary or riverbed is via one or more mooring line(s) the composition of which may typically be any combination of wire, chain or rope segments or rigid connecting elements.

47. Method as claimed in claim 42 wherein the apparatus is connected to a separate floating or fixed structure.

48. (canceled)

49. Method as claimed in claim 42 wherein said apparatus is permanently fixed in the direction of water flow.

50. Method as claimed in claim 42 wherein said apparatus is allowed to rotate to continually face the direction of flow of the water.
